(19) United States
(12) Patent Application Publication
(10) Pub. No.: US 2012/0161091 A1
(43) Pub. Date: Jun. 28, 2012

(54) SINGLE-USE JACK

(76) Inventor: James Livingston, El Sobrante, CA (US)

(21) Appl. No.: 13/329,151

(22) Filed: Dec. 16, 2011

Related U.S. Application Data
(60) Provisional application No. 61/427,554, filed on Dec. 28, 2010.

(51) Int. Cl. B66F 3/24

(52) U.S. Cl. 254/93 R

(57) ABSTRACT

A compact, easy to use, single-use jack is provided. The jack includes an expandable volume formed from nested cylinders and a mechanism to fill the volume, under pressure, with a foam. When the foam is released, the volume expands, increasing the height of the jack. The jack may be safely stored and may be actuated to provide force when needed.

### CROSS-REFERENCE TO RELATED APPLICATIONS

This application claims the benefit of U.S. Provisional Application No. 61/427,554 filed Dec. 28, 2010. The entire contents of the above-listed provisional application are hereby incorporated by reference herein and made part of this specification.

### BACKGROUND OF THE INVENTION

1. Field of the Invention

The present invention generally relates to a device for lifting objects, and more particularly to a portable, single-use device for lifting heavy objects.

2. Discussion of the Background

There is a need in the art for a portable jack-like device that may be used to lift heavy objects in an emergency. Such a device should be light weight, compact, easy to use, and inexpensive.

### BRIEF SUMMARY OF THE INVENTION

The present invention overcomes the disadvantages of prior art by providing a device having an expandable internal volume and a mechanism for rapidly filling the volume such that the device may support a heavy load.

Certain embodiments provide a single-use jack comprising: a container having an internal volume and an expandable height; and a mechanism within the container to generate a foam within the container. The foam at least partially solidifies when expanded, such that the foam increases the height of the container and provides support for an object placed on or supported by the jack.

In certain other embodiments, a single-use jack is provided comprising: two or more nested cylinders having an internal volume, a maximum diameter, and an expandable height; and a mechanism within the two or more nested cylinders to generate a foam within the two or more nested cylinders and increase the height of the nested cylinders. The foam provides support for an object placed on or supported by the jack.

These features together with the various ancillary provisions and features which will become apparent to those skilled in the art from the following detailed description, are attained by the jack of the present invention, preferred embodiments thereof being shown with reference to the accompanying drawings, by way of example only, wherein:

### BRIEF DESCRIPTION OF THE SEVERAL VIEWS OF THE DRAWING

FIG. 1A is a side view illustrating the general features of various embodiments a jack prior to use;

FIG. 1B is a side view of the jack of FIG. 1A in a partially expanded configuration;

FIG. 1C is a side view of the jack of FIG. 1B in a further expanded configuration;

FIG. 1D is a side view of the jack of FIG. 1C in a fully expanded configuration;

FIG. 2A is a side sectional view 2A-2A of FIG. 1A;

FIG. 2B is a side sectional view 2B-2B of FIG. 1B;

FIG. 2C is a side sectional view 2C-2C of FIG. 1C;

FIG. 2D is a side sectional view 2D-2D of FIG. 1D;

FIG. 3 is a top view of the jack embodiment of FIG. 1;

FIG. 4 is bottom view of the jack embodiment of FIG. 1;

FIG. 5A is top sectional view 5A-5A of FIG. 1A of a first embodiment of the jack prior to use;

FIG. 5B is top sectional view 5B-5B of FIG. 1B of the first embodiment of the jack when actuated;

FIG. 6 is side sectional view 6-6 of FIG. 5A

FIG. 7A is top sectional view 7A-7A of FIG. 1A of a second embodiment of the jack prior to use;

FIG. 7B is top sectional view 7B-7B of FIG. 1B of the second embodiment of the jack when actuated;

FIG. 8A is top sectional view 8A-8A of FIG. 1A of a third embodiment of the jack prior to use;

FIG. 8B is top sectional view 8B-8B of FIG. 1B of the third embodiment of the jack, when actuated;

FIG. 9A is sectional view 9A-9A of FIG. 8A;

FIG. 9B is sectional view 9B-9B of FIG. 8B;

FIG. 10A is top sectional view 10A-10A of FIG. 1A of a fourth embodiment of the jack prior to use;

FIG. 10B is top sectional view 10B-10B of FIG. 1B of the fourth embodiment of the jack when actuated;

FIG. 11A is sectional view 11A-11A of FIG. 10A;

FIG. 11B is sectional view 11B-11B of FIG. 10B;

FIG. 12A is a side view of an alternative jack prior to use;

FIG. 12B is a side view of the jack of FIG. 12A in a fully expanded configuration;

FIG. 13A is a sectional view 13A-13A of FIG. 12A;

FIG. 13B is a section view 12B-12B of FIG. 12B;

FIGS. 13C, 13D, and 13E are views 13B of three alternative jack embodiments;

FIG. 14A is top sectional view 14A-14A of FIG. 1A of a fifth embodiment of the jack prior to user;

FIG. 14B is top sectional view 14B-14B of FIG. 1B of the fifth embodiment of the jack when actuated;

FIG. 15A is sectional view 14A-14A of FIG. 10A of the jack prior to use; and

FIG. 15B is sectional view 14B-14B of FIG. 10B of the jack when actuated.

Reference symbols are used in the Figures to indicate certain components, aspects or features shown therein, with reference symbols common to more than one Figure indicating like components, aspects or features shown therein.

### DETAILED DESCRIPTION OF THE INVENTION

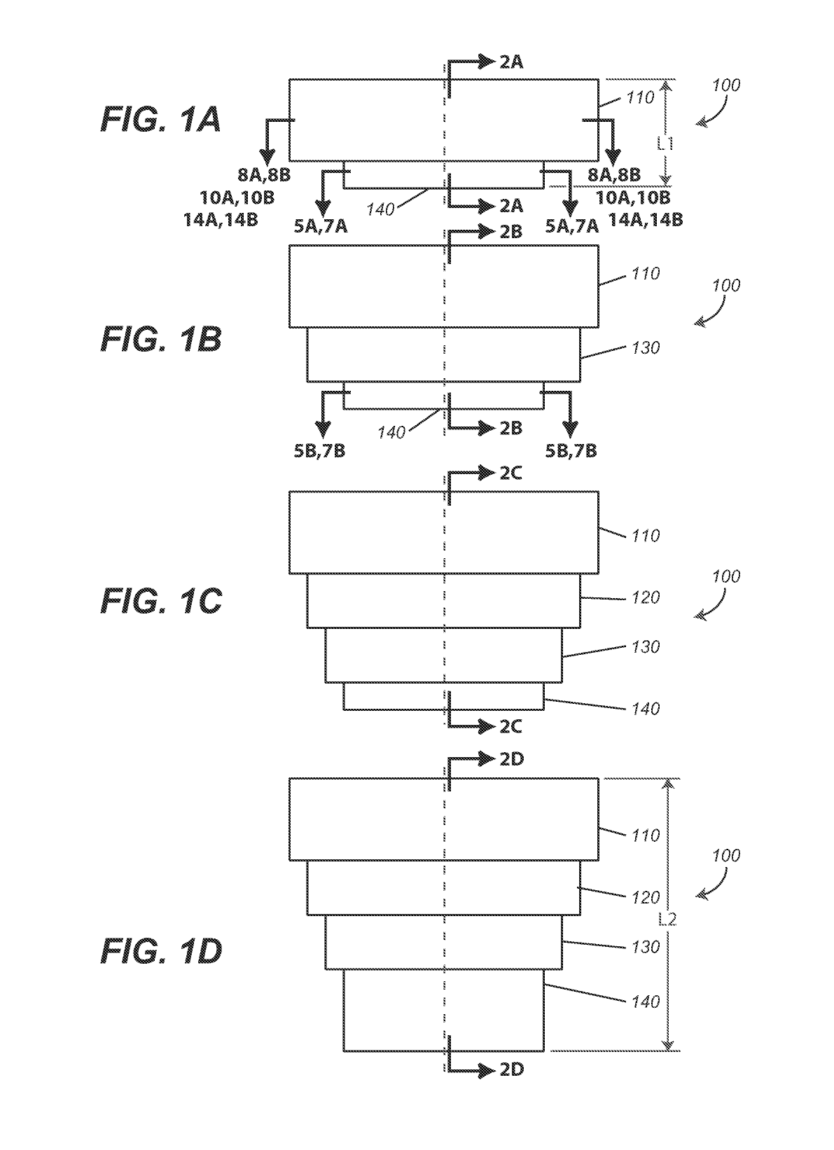

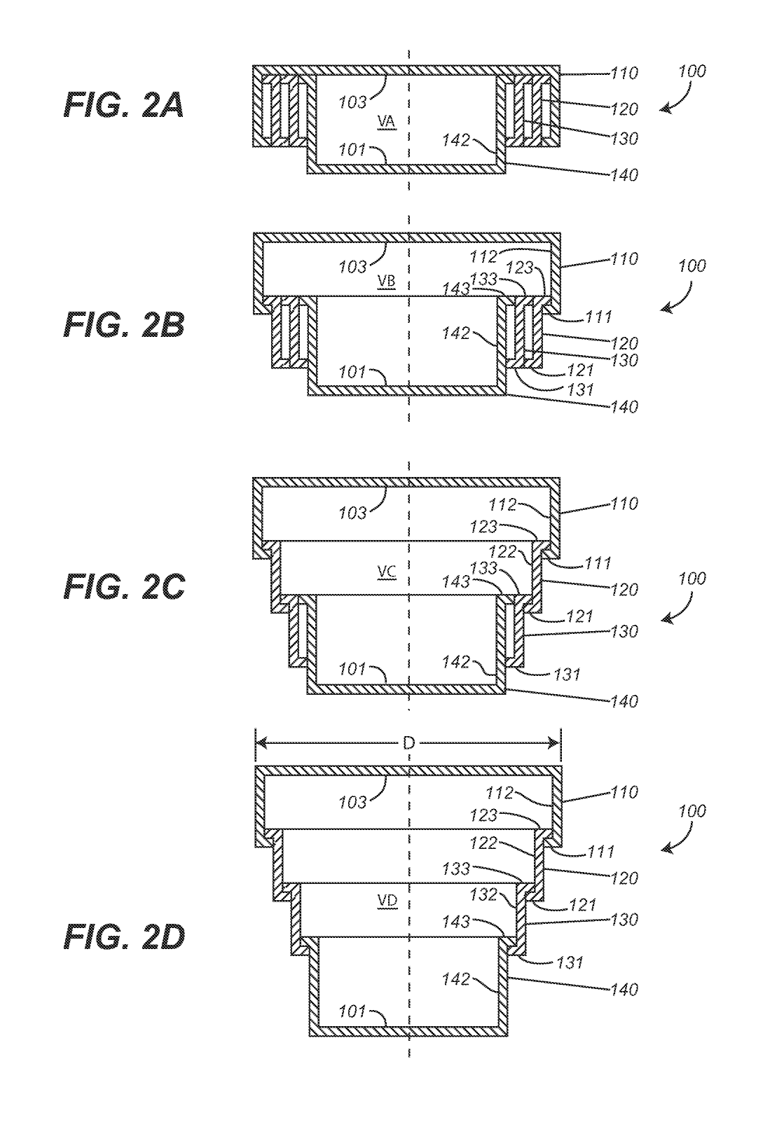

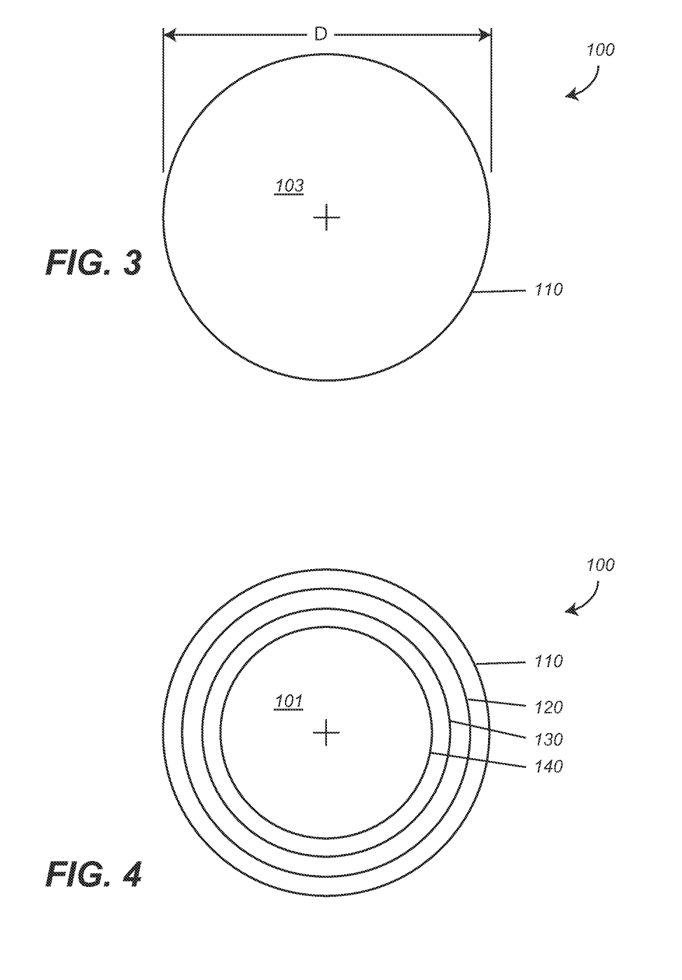

The Figures illustrate a single-use jack 100, where: FIG. 1A is a side view illustrating the general features of various embodiments of the jack prior to use and FIG. 2A is a side sectional view 2A-2A of FIG. 1A; FIG. 1B is a side view of the jack in a partially expanded configuration and FIG. 2B is a side view 2B-2B of FIG. 1B; FIG. 1C is a side view of the jack in a further expanded configuration and FIG. 2C is a side view 2C-2C of FIG. 1C; and FIG. 1D is a side view of the jack of FIG. 1C in a fully expanded configuration and FIG. 2D is a side view 2D-2D of FIG. 1D. In addition, FIG. 3 is a top view of jack 100 and FIG. 4 is bottom view of the jack.

Jack 100 has a cylindrical tapered shape, as illustrated in FIGS. 1-4 and includes several nested cylinders including a first cylinder 110, a second, slightly smaller diameter cylinder 120, a third yet smaller diameter cylinder 130, and a fourth smallest diameter cylinder 140. As shown in FIGS. 2A-2D, cylinder 110 has a top 103, a wall 112, and a bottom lip 111, cylinder 120 has a top lip 123, a wall 122, and a bottom lip 121, cylinder 130 has a top lip 133, a wall 132, and a bottom lip 131, and cylinder 140 has a top lip 143, wall 142, and bottom 101. Although the Figures show four nested cylinders, the number of nested cylinders in jack 100 may be more or less than for. Thus, for example jack 100 may be formed from 2 or 3 nested cylinders, or from 5, 6, or more nested cylinders.

Walls 112, 122, 132, and 142 and lips 111, 121, 123, 131, 133, and 143 are sized and configured to allow cylinders 110, 120, 130, and 140 to slide as nested cylinders. Walls 112, 122, 132, and 142, lips 111, 121, 123, 131, 133, and 143, and bottom 101 and top 103 form a generally sealed internal volume of variable size which is illustrated as volume VA in FIG. 2A, volume VB in FIG. 2B, volume VC in FIG. 2C, and volume VD in FIG. 2D. Specifically, jack 100 has a diameter D and a stored, or unused configuration as shown in FIGS. 1A and 2A with height L1, and a fully expanded configuration as shown in FIGS. 1D and 2D with a height L2, while FIGS. 1B, 2B, 1C and 2C illustrate intermediate volumes.

In certain embodiments, a mechanism is provided within volume VA that allows jack 100 to lift heavy objects. Thus, for example and without limitation, volume VA may be provided with a high pressure medium or a mechanism that generates a high pressure, causing bottom 101 and top 103 to move apart from each another as the volume increases from volume VA to volume VD. In certain other embodiments, for example and without limitation, volume VA is provided with a material that expands and hardens, thus providing a force to move bottom 101 and top 103 apart from each other.

In one embodiment jack 100 has an unexpanded height L1 and a fully expanded volume L2, where the ration L2/L1 is, for example and without limitation, from 4 to 12. Thus, for example and without limitation, for a height L1 of ½ inch, jack 100 expands to a height L2 of 6 inches. In another embodiment, jack 100 has a diameter D of from 2 inches to 6 inches.

In one embodiment, cylinders 110, 120, 130, and 140 are formed from a metal, including but not limited to, aluminum or steel, or a strong plastic. In other embodiment, one or more of cylinders 110, 120, 130, and 140 may include a corrugated material sandwiched between cylindrical and/or flat walls.

In certain embodiments, jack 100 contains compounds (not shown in FIG. 2) that, when activated, form a foam and cause the jack to expand in size as shown, for example, in the sequence FIGS. 1A, 1B, 1C, and 1D. In certain other embodiments, the compounds are stored, prior to use, in separate pouches or compartments as compounds A and B. Thus, for example, a sufficient quantity of compound A and compound B are stored within volume VA to fully expand into a foam that occupies substantially the entire volume VD. In one embodiment, the foam hardens over a relatively short period of time, resulting in an extended jack that can support weight due to the rigidness of the resulting foam. In certain other embodiments, jack 100 is thus not reusable, and is thus a one-time use jack.

The use of foaming compounds is well known in the field. In one embodiment, compound A and compound B, for example and without limitation, are resins. In one specific embodiment, compound A and compound B are the compounds of ICYNENE LD-CP-50™ Pour Fill Formula insulation (manufactured by Icynene, Inc, Mississauga, Ontario, Canada)

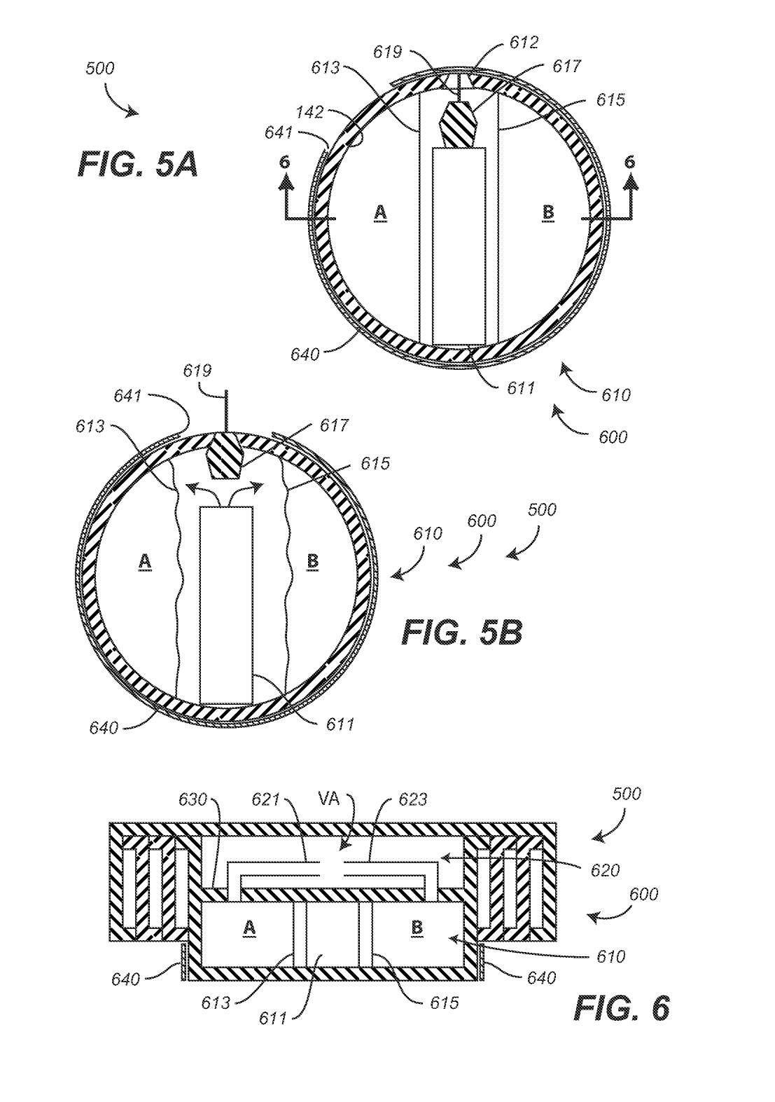

FIGS. 5A, 5B, and 6 are various views of a first embodiment of jack 500 in a top sectional view 5A-5A of FIG. 1A of the jack prior to use, a sectional view 5B-5B of FIG. 1B of the jack when actuated, and a side sectional view 6-6 of FIG. 5A. Jack 500 may be generally similar to jack 100, except as further detailed below. Where possible, similar elements are identified with identical reference numerals in the depiction of jacks 100 and 500.

As described subsequently, the jack 500 includes a mechanism 600 for pressurizing the internal volume of the jack using two compounds (“A” and “B”) which, when mixed, expand to form a foam. This mechanism is exemplary, and is provided as one possible device for actuating jack 1500.

As shown in FIG. 6, volume VA includes a mechanism 600 to pressurize the volume, where the volume includes: a lower volume portion 610 and a lower volume portion 620 separated by a divider 630. Lower volume portion 610 includes a pressurized container 611; a first compound A, and a second compound B. Upper volume portion 620 includes a first nozzle 621 that provides fluid communication between first compound A and the upper volume portion, and a second nozzle 623 that provides fluid communication between the second compound B and the upper volume portion.

As shown in the stored configuration of FIG. 5A, lower volume portion 610 further includes a first flexible membrane 613 containing compound A and a second flexible membrane 615 containing compound B. Flexible membranes 613 and 615 may either completely surround compounds A and B, or may be attached to wall 142. Pressurized container 611 includes a valve/stopper 617 having a pull tab 619 that extends through a small hole 612 in wall 142. A rotatable cover 640 having a cover opening 641 surrounds the lower volume portion 610.

In the configuration of FIG. 5A, valve/stopper 617 prevents fluid from escaping pressurized container 611, rotatable cover 640 covers hole 612, thus preventing pull tab 619 from being accessed without first rotating the rotatable cover. As shown in FIG. 5B, rotatable cover 640 has been rotated to expose pull tab 619. Pull tab 619, which actuates jack 100, has been pulled, allowing gas to escape from pressurized container 611. In certain embodiments, pressurized container 611 is a CO2 cartridge. In certain other embodiments, pressurized container 611 provides a gas or liquid at pressures of from 2 atmospheres to 10 atmospheres.

Further, as shown in FIG. 5B, when jack 500 is actuated, valve/stopper 617 is forced into hole 612. The force, which may result from the action of pull tab 619 and/or the increased pressure in the lower volume portion 610, seals off the internal volume (that is, VA, VB, VC, VD, etc.) of jack 100 and allows the fluid from pressurized container 611 to fill the internal volume of the jack.

As further shown in FIG. 5B, the pressure increases the pressure within compound A and compound B, which causes compound A and compound B to flow though nozzles 621 and 623, respectively. Nozzles 621 and 623 are directed towards each other in upper volume portion 620, which permits compound A and compound B to mix and react with each other. As compound A and compound B are forced into upper volume portion 620, flexible membranes 613 and 615 deform, as shown in FIG. 5B.

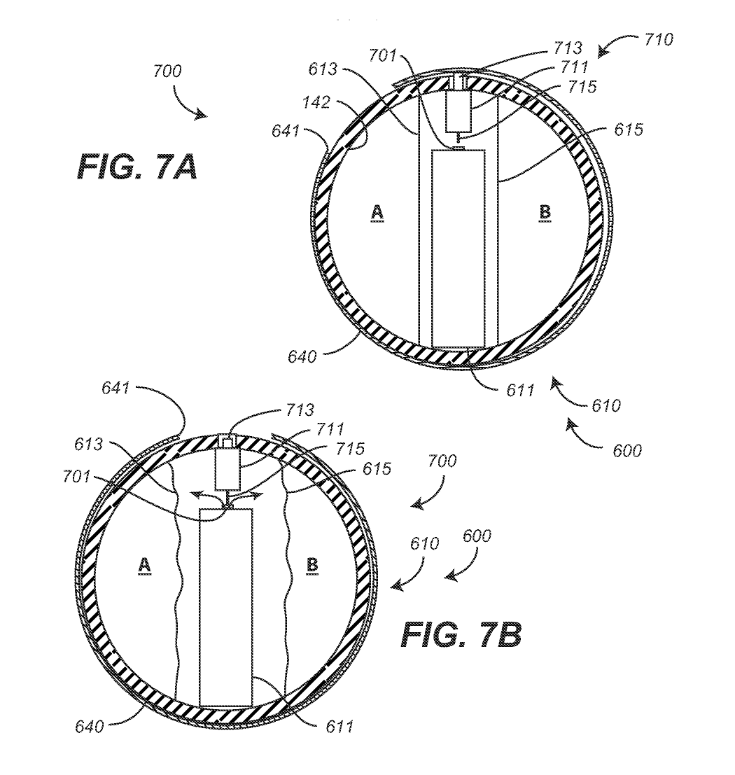

A second embodiment jack 700 is illustrated in FIGS. 7A and 7B, where FIG. 7A is top sectional view 7A-7A of FIG. 1A of the jack prior to use, and FIG. 7B is top sectional view 7B-7B of FIG. 1B of the jack when actuated. Jack 500 may be generally similar to jack 100 or 500, except as further detailed below. Where possible, similar elements are identified with identical reference numerals in the depiction of jacks 100, 500, and 700.

Mechanism 600 of jack 700 includes a plunger 710 having a pin 715 in proximity to an end 701 of container 611 and a button 713 that protrudes through wall 142. Prior to use (as in FIG. 7A), cover 640 covers button 713, preventing the accidental use of jack 700. To actuate mechanism 600 (as in FIG. 7B), cover 640 may be rotated to expose button 713 through opening 641, allowing button 713 to be pushed, which activates jack 700 by pin 715 puncturing container 611 and releasing pressurized gas to cause the mixing of compounds A and B, such as those described previously.

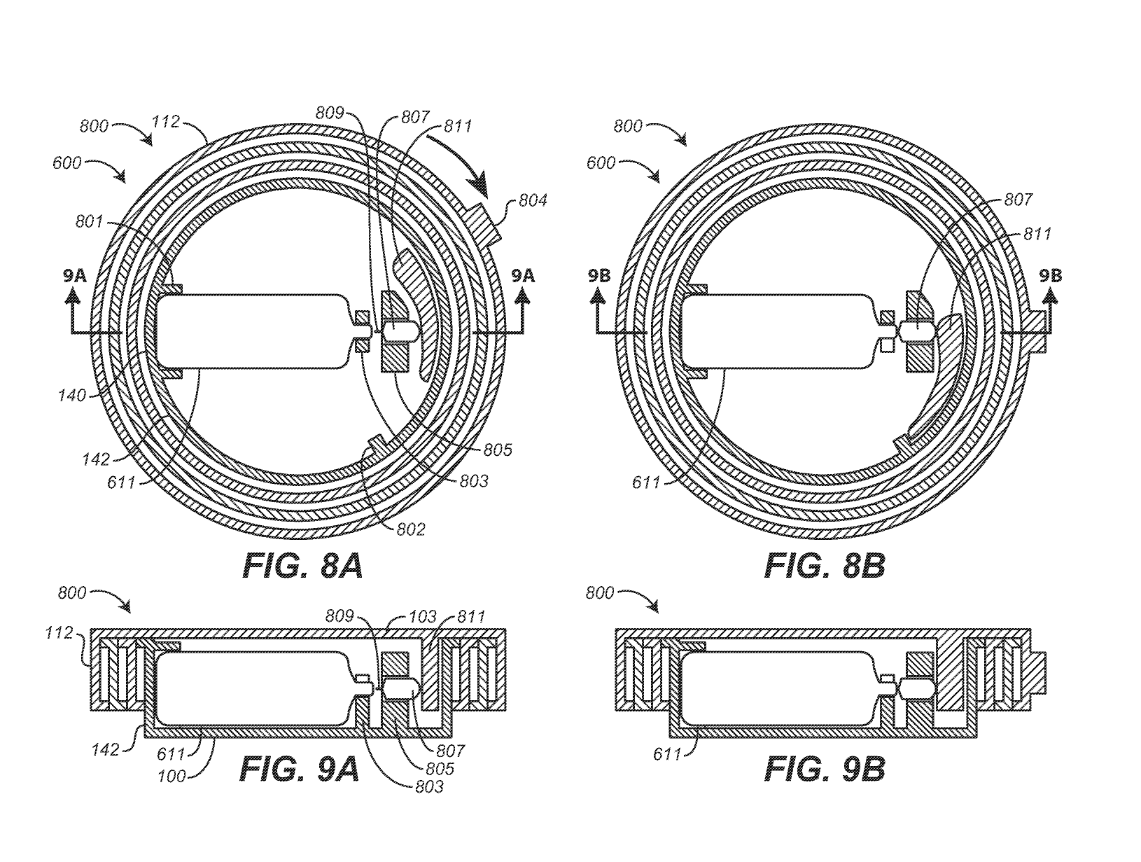

A third embodiment jack 800 is illustrated in FIGS. 8A, 8B, 9A and 9B, where FIG. 8A is top sectional view 8A-8A of FIG. 1A of the jack prior to use, FIG. 8B is top sectional view 8B-8B of FIG. 1B of the jack when actuated, FIG. 9A is sectional view 9A-9A of FIG. 8A, and FIG. 9B is sectional view 9B-9B of FIG. 8B. Jack 800 may be generally similar to jack 100, 500 or 700 except as further detailed below. Where possible, similar elements are identified with identical reference numerals in the depiction of jacks 100, 500, 700 or 800.

FIGS. 8A, 8B, 8A, and 8B illustrate the portions of mechanism 600 of jack 800 that provide an alternative mechanism to container 611 and do not show compounds A and B, which are present but which are not illustrated on these figures. Specifically, mechanism 600 includes container 611 which is held in place on cylinder 140 by portions 801 on wall 142 and portion 803 on bottom 101, a plunger 807 having a pin 809, which is allowed to slide toward or away from container 611 by plunger holder 805, and a cam 811 attached to top 103.

Jack 800 is activated by rotating cylinder 110 relative to cylinder 140 from the position in FIGS. 8A and 9A to a position where cam 805 contacts a stop 802 on wall 142 as shown in FIGS. 8B and 9B. The rotation of the cylinders causes cam 811 to push plunger 807, puncturing container 611 and thus activating jack 800. Cylinder 110 may also be provided with protrusions, such as protrusion 804 to facilitate the rotation by the fingers of the user. Jack 800 may then increase in size, as from FIG. 1A to FIG. 1D.

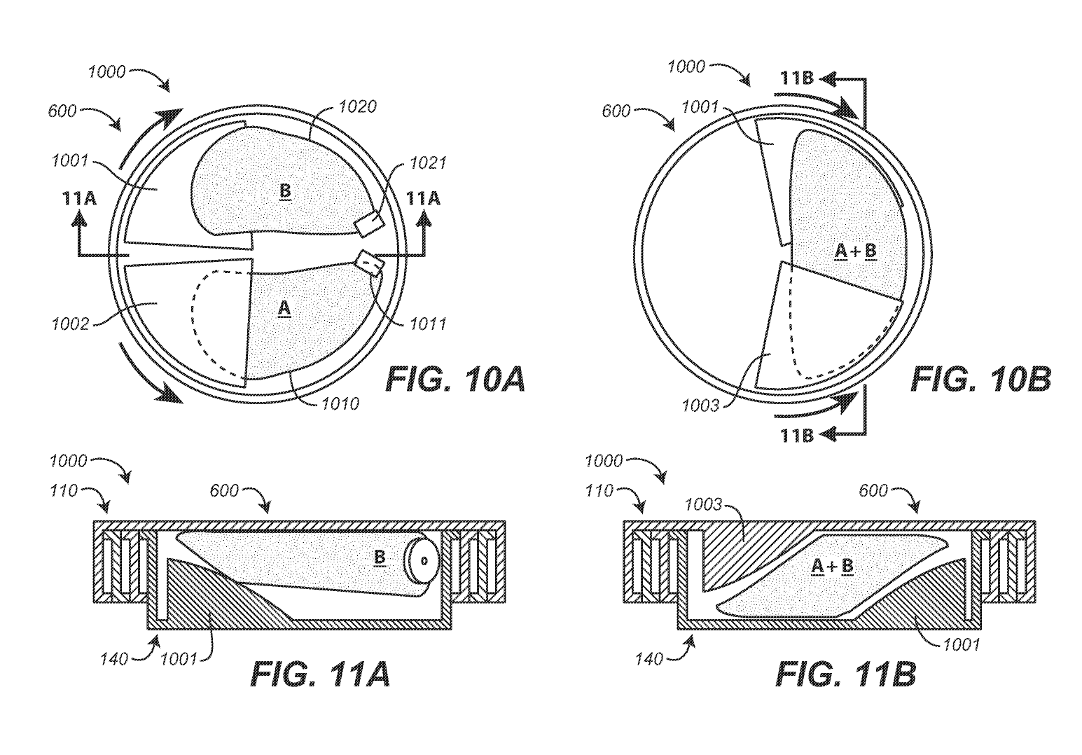

A fourth embodiment jack 1000 is illustrated in FIGS. 10A, 10B, 11A, and 11B, where FIG. 10A is top sectional view 10A-10A of FIG. 1A of the jack prior to use, FIG. 10B is top sectional view 10B-10B of FIG. 1B of the jack when actuated, FIG. 11A is sectional view 11A-11A of FIG. 10A, and FIG. 11B is sectional view 11B-11B of FIG. 10B. Jack 1000 may be generally similar to jack 100, 500, 700 or 800, except as further detailed below. Where possible, similar elements are identified with identical reference numerals in the depiction of jacks 100, 500, 700, 800, or 1000.

Mechanism 600 of jack 1000 includes compound A, stored in a pouch 1010 with a nozzle 1011, compound B, stored in a pouch 1020 with a nozzle 1021, a protrusion 1001 attached to cylinder 140, and a protrusion 1003 is attached to cylinder 110. Mechanism 600 of jack 1000 mixes compounds A and B without the assistance of a pressurized container. As in jack 800, a user rotates cylinder 140 relative to cylinder 110, from the position in FIGS. 10A and 11A to the position in FIGS. 10B and 11B. Protrusion 1001 pushes the pouch containing compound B and protrusion 1003 pushes the pouch containing compound B. Compounds A and B escape from nozzles 1011 an 1012, respectively, to mix and foam, as shown in FIGS. 10B and 11B. Jack 1000 may then increase in size, as from FIGS. 1A to FIG. 1D.

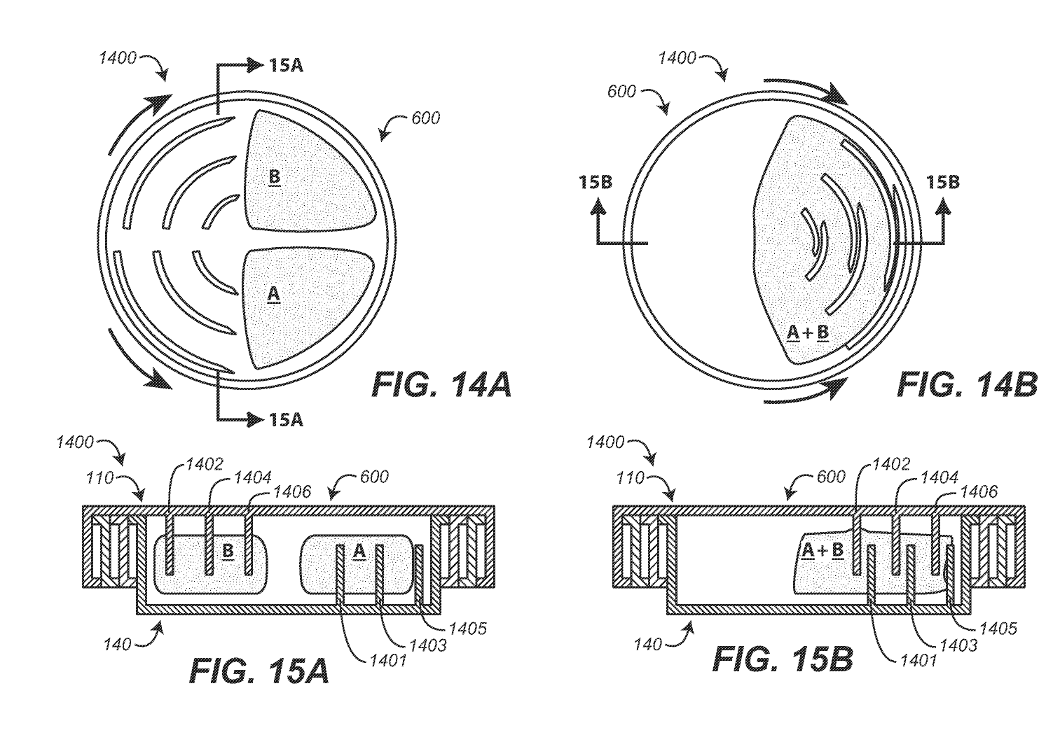

A fifth embodiment jack 1400 is illustrated in FIGS. 14A, 14B, 15A, and 15B, where FIG. 14A is top sectional view 14A-14A of FIG. 1A of the jack prior to use, FIG. 14B is top sectional view 14B-14B of FIG. 1B after being actuated, FIG. 15A is sectional view 15A-15A of FIG. 14A, and FIG. 15B is sectional view 15B-15B of FIG. 14B. Jack 1400 may be generally similar to jack 100, 500, 700, 800, or 1000, except as further detailed below. Where possible, similar elements are identified with identical reference numerals in the depiction of jacks 100, 500, 700, 800, 1000, or 1400.

Mechanism 600 of jack 1400 includes a plurality of blades 1401, 1403 and 1405 attached to cylinder 140 and a plurality of blades 1402, 1404 and 1406 attached to cylinder 110. Blades 1401, 1402, 1403, 1404, 1405, and 1406, are arcs that intermesh when cylinders 110 and 140 are rotated.

As shown in FIGS. 14A and 15A, blades 1401, 1402, 1403, 1404, 1405, and 1406 are at first not in contact with the pouches containing compounds A and B. As cylinders 110 and 140 are rotated, blades 1401, 1402, 1403, 1404, 1405, and 1406 interleave, puncturing the A and B pounces and acting as mixing blades to mix compounds A and B. Jack 1400 may then increase in size, as from FIGS. 1A to FIG. 1D.

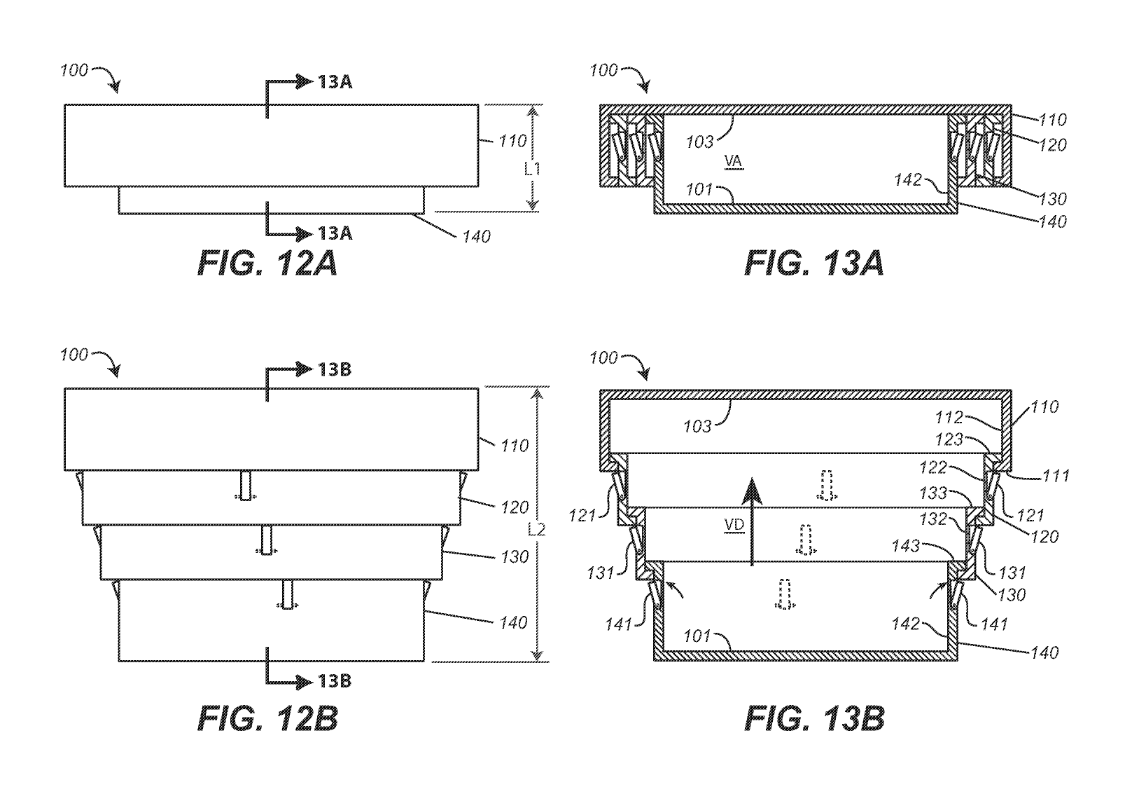

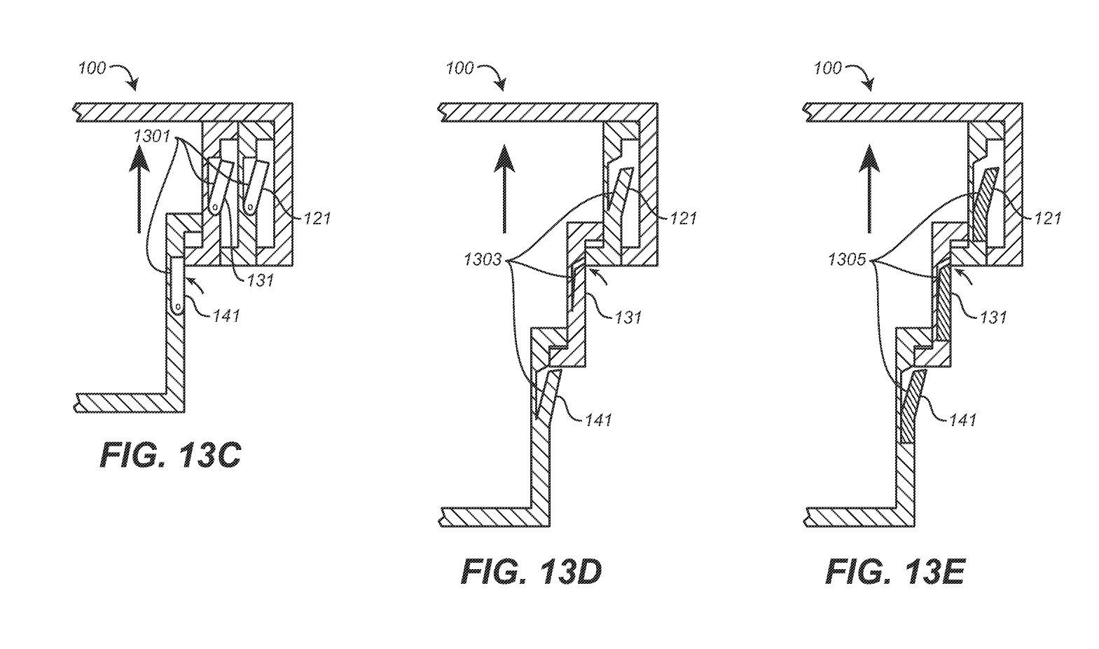

FIGS. 12 and 13 illustrate alternative embodiments of jack 100 that may be used to help maintain the jack in the fully expanded configuration of FIG. 1D. Thus, for example, FIGS. 12A and 13A illustrate one embodiment of jack 100 in a configuration similar to that of FIG. 1A and FIGS. 12B and 13B illustrate the embodiment fully extended, as in FIG. 1D. The embodiments shown in FIGS. 12 and 13 may be used with any of the other jack embodiments described herein.

The alternative embodiment of jack 100 in FIGS. 12 and 13 includes cylinder 120 with one or more mechanism 121, cylinder 130 with one or more mechanism 131, and cylinder 140 with one or more mechanisms 141. In general, mechanism 121, 131, and 141 provide a ratchet mechanism that lock into place when adjacent cylinders are extended, as shown in FIGS. 12B and 13B. Mechanisms 121, 131, and 141 may be for example and without limitation, spring loaded levers or portions of the cylinders that are left with or provided with a residual stress to prefer an extended configuration. The mechanisms of adjacent cylinders may either be in line with one another or be displaced, as shown in FIGS. 12B and 13B.

FIGS. 13C, 13D, and 13E are views 13B of three alternative jack embodiments illustrating mechanisms 121, 131, and 141 in various states of actuation. In general, mechanisms 121 move from an outward configuration prior to jack use, bend inwards at the cylinders move past one another, and then extend outwards, locking cylinders in a fully extended configuration.

In FIG. 13C, mechanisms 121, 131, and 141 are spring loaded metal or plastic levers 1301. In FIG. 13D, mechanisms 121, 131, and 141 are protrusions 1303 of the cylinders to which they are attached. In FIG. 13E, mechanisms 121, 131, and 141 are metal springs 1305 that are attached to each of the cylinders.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

I Claim:

1. A single-use jack comprising:
a container having an internal volume and an expandable height; and
a mechanism within said container to generate a foam within said container,
wherein the foam at least partially solidifies when expanded,
such that the foam increases the height of said container and provides support for an object placed on or supported by said jack.

2. The single-use jack of claim 1, where said container includes two or more nested cylinders, and wherein said expandable internal volume includes the internal volume of said two or more nested cylinders having a combined height and expandable volume.

3. The single-use jack of claim 1, wherein said mechanism includes one or more compounds that form a foam.

4. The single-use jack of claim 3, wherein said one or more compounds are a pair of liquids that, when mixed, form a foam.

5. The single-use jack of claim 3, wherein said one or more compounds are compounds of an insulation foam spray.

6. The single-use jack of claim 3, further comprising a container for storing a pressurized fluid, wherein said pressurized fluid forces generates a foam of said one or more compounds.

7. The single-use jack of claim 6, wherein said container is plugged with a stopper, and wherein said container includes a hole to provide access to stopper, such that when said stopper is removed from said container to actuate said jack, said stopper plugs said hole to seal of the internal volume of said container.

8. The single-use jack of claim 4, where said container includes two or more nested cylinders, wherein said expandable internal volume includes the internal volume of said two or more nested cylinders having a combined height and expandable volume, and where said mechanism includes portions of at least two of said two or more nested cylinders that, when rotated relative to one another, mix said pair of liquids.

9. The single-use jack of claim 2, wherein said container includes nested cylinders having a maximum diameter of from 2 inches to 6 inches.

10. The single-use jack of claim 9, wherein the ratio of the maximum height of said nested cylinders to the minimum height of said nested cylinders is from 4 to 12.

11. The single-use jack of claim 9, wherein said nested cylinders have a minimum height of 0.5 inches.

12. The single-use jack of claim 9, wherein said nested cylinders have a maximum height of 6 inches.

13. The single-use jack of claim 9, wherein said nested cylinders includes 2, 3, 4, or 5 nested cylinders.

14. A single-use jack comprising:
two or more nested cylinders having an internal volume, a maximum diameter, and an expandable height; and
a mechanism within said two or more nested cylinders to generate a foam within said two or more nested cylinders and increase the height of said nested cylinders,
such that the foam provides support for an object placed on or supported by said jack.

15. The single-use jack of claim 14, wherein said mechanism includes a container for storing a pressurized fluid, and one or more compounds that form a foam.

16. The single-use jack of claim 15, wherein said one or more compounds are compounds of an insulation foam spray.

17. The single-use jack of claim 15, wherein said pressurized fluid forces generates a foam of said one or more compounds.

18. The single-use jack of claim 15, wherein said container is plugged with a stopper, and wherein said nested cylinders includes a hole to provide access to stopper, such that when said stopper is removed from said container to actuate said jack, said stopper plugs said hole to seal of the internal volume of said nested cylinders.

19. The single-use jack of claim 14, where said mechanism includes a pair of liquids that, when mixed, generate said foam, and where said mechanism includes portions of said cylinders that, when at least two of said cylinders are rotated relative to one another, mix said foam.

20. The single-use jack of claim 14, wherein said nested cylinders have a maximum diameter of from 2 inches to 6 inches.

21. The single-use jack of claim 14, wherein the ratio of the maximum height of said nested cylinders to the minimum height of said nested cylinders is from 4 to 12.

22. The single-use jack of claim 14, wherein said nested cylinders have a minimum height of 0.5 inches.

23. The single-use jack of claim 14, wherein said nested cylinders have a maximum height of 6 inches.

24. The single-use jack of claim 14, wherein said nested cylinders includes 2, 3, 4, or 5 nested cylinders.
